(19) United States
(12) Patent Application Publication
(10) Pub. No.: US 2004/0103314 A1
(43) Pub. Date: May 27, 2004

(54) System and method for network intrusion prevention

(76) Inventor: Thomas F. Liston, McHenry, IL (US)

Correspondence Address: MERONI + MERONI, P.O. BOX 309, BARRINGTON, IL, 60011, US

(21) Appl. No.: 10/308,980

(22) Filed: Nov. 27, 2002

(51) Int. Cl. H04L 9/00

(52) U.S. Cl. 713/201

(57) ABSTRACT

A method and system for protecting a computer network against unauthorized users probing computer networks for vulnerabilities. The method comprises monitoring a computer network for communications from Internet protocol addresses directed toward unused Internet protocol addresses within the computer network. Internet protocol addresses sending communications directed toward unused Internet protocol addresses within the computer network are recorded as violators. Counter measures are initiated against Internet protocol addresses recorded as violators protecting the computer network from intrusion. The system comprises a monitoring means monitoring communications sent locally in response to communications from Internet protocol addresses to local Internet protocol addresses within a computer network. A recording means records Internet protocol addresses attempting to send communications to unused local Internet protocol addresses. A communication means communicates with Internet protocol addresses performing counter measures against recorded Internet protocol addresses protecting the computer network from intrusion.

### BACKGROUND OF THE INVENTION

1. Field of the Invention

The present invention generally relates to computer networks. More specifically, the present invention relates to systems and methods for preventing unauthorized intrusions into computer networks.

2. Description of the Prior Art

When a hacker, virus, or Internet worm is attempting to attack an Internet-connected network, the most common method that is used to gather data and identify potential targets is by “scanning” or sequentially connecting to Internet Protocol (IP) addresses to find weak systems to exploit. These attackers generally use automated scanning tools or probes to quickly survey thousands of Internet addresses without human intervention. Once they detect a vulnerable system that is not properly secured, it can then be penetrated and compromised, creating a “slave” machine available for the use of the hacker, worm, or virus. Recent global attacks by worms such as Nimda and Code Red have caused considerable damage to corporate networks, and raised awareness of this vulnerable area of the Internet.

There are several different methods and systems in the prior art that generally deal with computer network security. Several previously issued United States Patents generally dealing with computer network security are discussed here.

U.S. Pat. No. 5,944,823 issued to Jade discloses a firewall that allows an inside user or object to originate connection to an outside object or network, but does not allow for connections to be generated in the reverse direction. The disclosed invention provides a special tunneling mechanism, operating on both side of the firewall, for establishing such “outside in” connections when they are requested by certain “trusted” individuals or objects or applications outside the firewall. This previously issued United States patent discloses a firewall for protecting a computer network that allows trusted users to gain access to the computer network, but does not disclose a method or system that identifies unauthorized attempts to infiltrate a computer network and perform proactive counter measures against the unauthorized users attempting to infiltrate the computer network.

U.S. Pat. No. 6,088,796 issued to Cianfrocca discloses a secure access query system incorporating a messenger system. The system includes a communication server for receiving queries from a user and transmitting replies to the user, an application server for providing replies to queries, a network firewall for preventing unauthorized access to the application server and a messenger system, coupled to the communication server for receiving queries from the communication server, transmitting the query across the network firewall along a secure pathway established by the application server between the messenger system means and the application server, receiving replies from the application server along the secure pathway and transmitting the replies to the communication server. This previously issued United States patent discloses a firewall for protecting a computer network that allows communication across the firewall, but does not disclose a method or system that identifies unauthorized attempts to infiltrate a computer network and perform proactive counter measures against the unauthorized users attempting to infiltrate the computer network.

U.S. Pat. No. 6,205,551 issued to Grosse discloses a technique for determining whether particular clients within a computer network are universally configured in accordance with the desired network security features of the computer network. A probe is randomly inserted within incoming files at a firewall in the computer network. The probe is configured as a function of a particular execution task such as a virus. If the client is properly configured, the probe will not execute and the firewall does not detect a security breach. However, if the client is not properly configured, the probe will execute and trigger an alarm in the firewall indicating that the client is vulnerable to a security breach. This previously issued United States Patent discloses identifying communications that do not match the computer network's security parameters, but does not disclose how to proactively prevent further unauthorized communications from infiltrating the computer network.

U.S. Pat. No. 6,363,489 issued to Comay et al. discloses a method and system for providing security to a network by at least identifying an unauthorized user who is attempting to gain access to a node on the network, and preferably by then actively blocking that unauthorized user form further activities. Preferably, further access to the network is then blocked by diverting traffic from the unauthorized user to a secure zone, where the activities of the unauthorized user can be contained without damage to the network. This previously issued United States patent discloses a method and system for identifying and dealing with unauthorized users, but does not disclose how to proactively counter act unauthorized attempts to infiltrate a computer network.

U.S. Patent Application Publication US2002/0013910A1 discloses a protection system and methods providing protection for personal computers and/or other network accessible devices from undesirable or otherwise malicious operations. A protection engine embodiment provides, within a server, firewall or other suitable “recommunicator,” for monitoring information received by the communicator, determining whether received information does or is likely to include executable code, and if so, causes mobile protection code (MPC) to be transferred to and rendered operable within a destination device of the received information, more suitably by forming a protection agent including the MPC, protection policies and a detected-Downloadable. An MPC embodiment further provides, within a Downloadable destination, for initiating the Downloadable, enabling malicious Downloadable operation attempts to be received by the MPC, and causing corresponding operations to be executed in response to the attempts, more suitably in conjunction with protection policies. This previously issued United States patent discloses a method of identifying malicious attempts at infiltrating a network and responding to the attempts, but does not disclose proactive counter acts to slow or prevent further infiltration attempts.

The random nature of automated scanning probes creates an inherent weakness that allows them to be detected and trapped. It is estimated that most corporate Internet connections use only 25% of the IP addresses assigned to their physical Internet connection, so there is a significant probability that at some point a probe will attempt to access an unused IP address on a given network. Since there is no legitimate reason for a corporate user, web surfer, or business partner to be connecting to such an address, that access attempt can immediately be defined as hostile. Therefore, there is a need for a method and system for monitoring computer networks for scanning probes attempting to connect to unused IP addresses within the network and performing counter measures to present proactive obstacles to further scanning activities by an unauthorized user.

### SUMMARY OF THE INVENTION

To fulfill the need for a method and system that monitors computer networks for scanning probes attempting to connect to unused IP addresses of a computer network while performing proactive counter measures to present obstacles to further scanning activities by unauthorized users, a method and system for network intrusion prevention is provided.

It is an object of the claimed invention to provide a method of monitoring address resolution protocol packet communications between computers on a local network, and network border routers to identify address resolution protocol packet communications addressed to unused IP addresses within the computer system.

It is a further object of the claimed invention to provide a method and system that creates virtual machines associated with unused IP addresses within a network to provoke further communications from an automated scanning probe.

It is an even further object of the claimed invention to provide a method and system that records IP addresses of entities attempting to infiltrate a computer network by monitoring communication attempts with unused IP addresses within a computer network.

It is a yet a further object of the claimed invention to provide a method and system that proactively presents obstacles to automated scanning probes to hinder further scanning of other local IP addresses.

The method of preventing unauthorized intrusions into a local computer network comprises monitoring local network computer responses to address resolution protocol requests initiated by communication from other Internet protocol addresses, either through a border router or local to the network. If a local computer sends an address resolution protocol acknowledgement in response to an address resolution protocol request, the Internet protocol address queried has its status recorded as being an occupied local Internet protocol address. If a local Internet protocol address does not send an address resolution protocol acknowledgement, the method virtually occupies an unused Internet protocol address after a predetermined number of address resolution protocol requests go unanswered. The method then records the status of the unused Internet protocol address queried as containing a virtually occupied Internet protocol address.

An address resolution protocol acknowledgement is created and sent by the method in response to the address resolution protocol request when an occupied Internet protocol address does not respond. This address resolution protocol acknowledgement creates the illusion that the Internet protocol address queried is occupied. The Internet protocol address sending the address resolution protocol request then forwards or sends the communications that initiated the address resolution protocol exchange. The Internet protocol address listed as the source of the communication is then recorded as a local violator.

Internet protocol communications are monitored to determine whether the communications are addressed to an occupied local Internet protocol address or a virtually occupied unused local Internet protocol address. Internet protocol addresses are checked against the local violator list. If the Internet protocol address is not recorded as a local violator, communications between that Internet protocol address and occupied local Internet protocol addresses are allowed. Further communications sent to virtually occupied unused local Internet protocol addresses or from a local violator initiates counter measures against the Internet protocol address sending the communication.

The method and system is capable of initiating three types of counter measures. A first counter measure simply breaks the connection between an Internet protocol address attempting to connect to the network by sending a first reset packet to the communication's destination Internet protocol address and a second reset packet to the source Internet protocol address. A second counter measure comprises completing the establishment of a connection between a violator Internet protocol address and a virtually occupied unused local Internet protocol address and then ignoring all further communications sent from the violator Internet protocol address thus slowing down automated scanning by a probe. A third counter measure comprises completing the establishment of a connection between a violator Internet protocol address and the virtually occupied unused local Internet protocol address, forcing the connection into a “persist” state by setting the Transmission Control Protocol receive window size to zero bytes, and intermittently acknowledging the receipt of Transmission Control Protocol receive window probes from the violator Internet protocol address thus capturing the probe until it is manually disconnected at the source of the violator Internet protocol address.

The method may further comprise encrypting the sequence number within an initial Internet protocol packet request to create the initial sequence number of the virtually occupied unused local Internet protocol address thus eliminating the need to locally track information on connections to virtually occupied unused Internet protocol addresses while maintaining verification of connections.

The claimed invention also provides a system for protecting a computer network against unauthorized users probing the network for unused Internet protocol addresses to exploit. The system generally comprises a monitoring means, recording means, and a communication means. The parameters of the protection system are accessed from a central location via a secured Internet website.

The monitoring means of the system monitors address resolution protocol packets sent locally in response to communications from Internet protocol addresses to local Internet protocol addresses.

The system has recording means that records Internet protocol addresses attempting to send communications to unused local Internet protocol addresses when the monitoring means monitors a predetermined number of unanswered address resolution protocol packets have been sent in response to communication attempts by Internet protocol addresses.

The system has communication means to communicate with Internet protocol addresses performing counter measures against recorded Internet protocol addresses. The communication means is capable of sending a partially encrypted transmission control protocol packet in response to transmission control protocol packets sent from Internet protocol addresses directed toward unused local Internet protocol addresses. To delay automated probes from scanning Internet protocol addresses, the communication means is capable of establishing a connection with Internet protocol addresses attempting to send communications to unused local Internet protocol addresses and ignoring further communications slowing the progress of automated probes. The communication means is also capable of sending reset communications to local Internet protocol addresses and Internet protocol addresses attempting to send communications to unused local Internet protocol addresses breaking the connection with the computer network. The communication means is further capable of sending a transmission control protocol packet setting a receive window of zero byte size and responding to transmission control protocol window probes from Internet protocol addresses by sending transmission control protocol packets maintaining a receive windows of zero byte size.

### BRIEF DESCRIPTION OF THE DRAWINGS

FIG. 1. FIG. 1 is a diagram of a computer network having a system of the claimed invention.

FIG. 2. FIG. 2 is a flow chart of an exemplary method and system where an inbound data packet is acted upon according to a server response to an ARP.

FIG. 3. FIG. 3 is a continuation of the flow chart in FIG. 2 where the inbound data packet is acted upon according to the violator list.

FIG. 4. FIG. 4 is a continuation of the flow chart in FIG. 3 where the violator list is sent to a central location for compilation with violator lists of other systems of the claimed invention.

### DETAILED DESCRIPTION OF THE PREFERRED EMBODIMENT

The claimed invention is a method and system for preventing unauthorized intrusions into local computer networks by creating virtual machines to occupy unused Internet protocol (IP) addresses within the local computer network and then performing counter measures against unauthorized users who probe local computer network IP addresses as a means of finding network vulnerabilities.

Unauthorized users are detected by monitoring the communications between a border router (or other local computer) and a local IP address initiated by a communication attempt directed at that local IP address to determine whether the communication is directed toward a used IP address associated with a real machine or computer in the network or toward an unused IP address within the network. Once the unauthorized communication has been identified as being directed toward an unused IP address, counter measures are used to end connection attempts, slow automated scanning rates, and capture scanning probes.

The principles and operation of the method and system according to the claimed invention may be better understood with reference to the drawings and the accompanying description, it being understood that these drawings are given for illustrative purposes only and are not meant to be limiting. Although the following detailed description centers upon a packet-switched network, in which communication is performed and data is transmitted in the form of packets, it is understood that this is for the purposes of description only, and is without any intention of being limiting, as the claimed invention is also operable with other types of networks.

The inventor of the claimed invention made available to the public an open-source network security application and system called LaBrea™ that performed several of the functions of the claimed invention. The open-source LaBrea™ system monitored only unused IP addresses in a computer network for connection attempts by sources outside of the computer network. The claimed invention provides a method and system that improves upon the open-source LaBrea™ system by dynamically building a status listing of all the IP addresses within the computer network that the system is configured to monitor and then dynamically generating a “Bad Guy” or violator list of IP addresses that attempt to connect to unused IP addresses within the computer network. This detailed description describes how the improved LaBrea™ method and system functions.

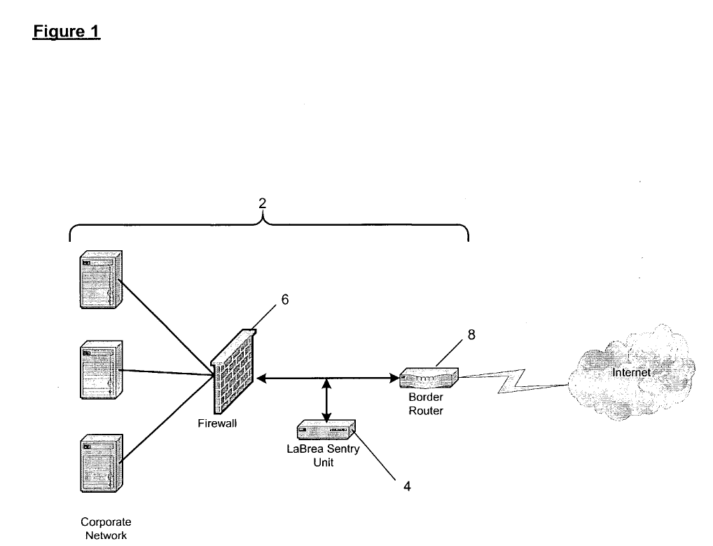

FIG. 1 is a diagram of a computer network 2 having an improved LaBrea™ system unit 4 of the claimed invention situated between a network firewall 6 and a network border router 8 of the computer network 2. Each LaBrea™ system unit 4 is essentially a personal computer having a network interface card connected to the computer network 2. The improved LaBrea™ software program is loaded onto the personal computer and the network interface card is placed into what is known as “promiscuous mode,” which enables the LaBrea™ system unit 4 to monitor all data packets 10 being transferred through the network connection where the system 4 is connected. The LaBrea™ system units 4 do not have local user interfaces. The parameters of the LaBrea™ system 4 are configurable via a website that allows users of the LaBrea™ system 4 to configure the settings of the LaBrea™ system 4 to fit their particular needs.

Computers communicate over a network link by way of several established protocols containing packets of data arranged in standard defined positions. Different types of protocols have been developed to perform different tasks in order to minimize unneeded information transfers. Several of these protocols are commonly arranged together so that computers of different types in different networks can effectively communicate with one another over the Internet. In order for these protocols to interact with one another, an Address Resolution Protocol (ARP) has been developed to resolve how sources and destinations are specified between higher level, distance-spanning protocols such as the Internet Protocol (IP) and lower level, local-communication protocols such as the Ethernet Protocol. The claimed invention monitors ARP packet activity to discover unused IP addresses within computer networks 2 and use connection attempts against those addresses to build a list of unauthorized violators.

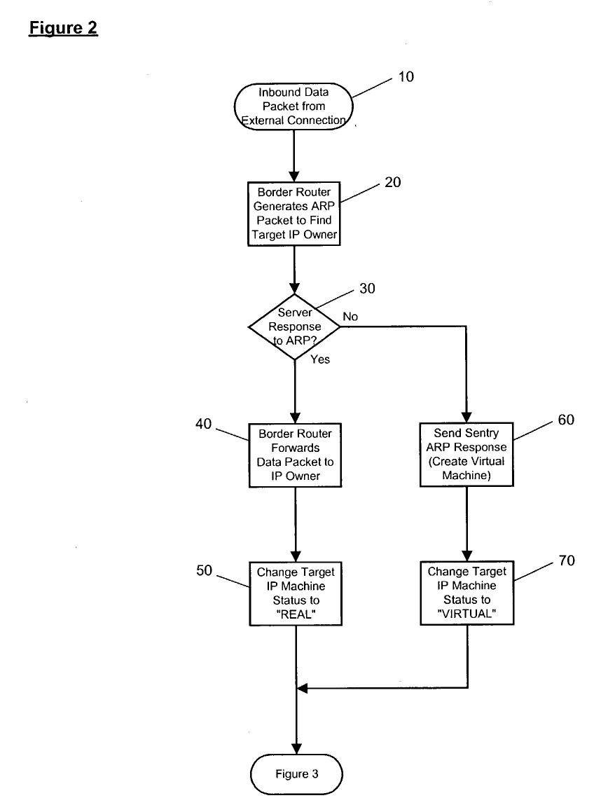

FIG. 2 is a flow chart of an exemplary method the system performs in monitoring ARP communications between a server and a border router or other local computer on the local computer network. An inbound data packet 10 created by an external network IP address or a local IP address attempts to communicate with a local IP address within the computer network. The border router or local computer generates an ARP packet 20 to find the IP address that the packet targets. If a computer at the target IP address responds to the ARP packet 30, the border router forwards 40 the inbound data packet 10 to the IP address that is occupied with a real machine of the computer network 2. The system 4, which monitors all of this traffic, then records the status of the IP address associated with the real machine as being “real” or “occupied” 50.

If a computer at the target IP address does not respond to the ARP packet, the method and system of the claimed invention sends a forged ARP response 60, which creates the appearance that a real machine is associated with the previously unused IP address. The system then records the status of the unused IP address as “virtually occupied” 70.

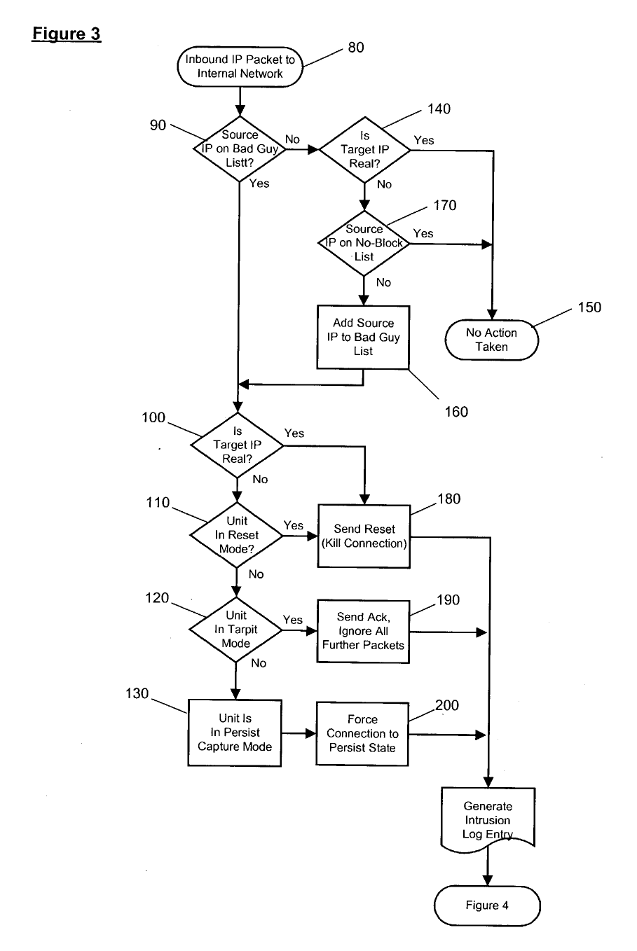

FIG. 3 is a continuation of the flow chart of FIG. 2. Subsequent inbound Internet Protocol (IP) packets 80 are monitored to determine whether the source IP address of the inbound packet 80 is recorded as a bad guy or violator on the bad guy list 90. If the IP address of the inbound packet is recorded on the bad guy list and the target IP address is the IP address of a real machine 100, the system performs counter measure 110.

If the source IP address is not listed on the bad guy list and the target IP address is real 140, no action is taken 150 by the system and the inbound packet communication 80 is allowed to interface with the target IP address.

If the source IP address is not on the bad guy list and the target IP address is virtually occupied by the method and system, the source IP is added to the bad guy list 160 if the source IP address is not listed on an override table 170 maintained by the user of the method and system 4. The system 4 then performs one of three counter measures 110, 120, 130 depending upon the user settings of the system 4.

The system and method provides three proactive counter measures 110, 120, 130 to prevent unauthorized users from connecting to IP addresses associated with real computers or to slow or capture an unauthorized users' automated scan of a computer network containing unused IP addresses.

A first counter measure 110 of the method and system is sending a reset signal to the local computer and to the source IP address of the inbound packet 80 to terminate the connection 180 between the source IP address and the computer network. This method is used to block connections to real or occupied IP addresses, and can be used to provide false information to scans of unused IP addresses. All further counter measures of the method and system 4 are used exclusively against connection attempts targeting unused IP addresses.

A second counter measure 120 of the method and system is sending an acknowledgement packet in response to the inbound connection initiation packet 10 and then ignoring further packets 80 from the source IP address 190. The source IP address will then attempt to send further communications to the virtually occupied IP address thus slowing the source IP address scanning progress.

A third counter measure 130 of the method and system is what is known as “persist capture” mode. The persist capture mode completes the establishment of a connection between a violator and a local virtually occupied IP address, and then sends a transmission control protocol (TCP) packet which sets a TCP receive window of zero byte size to the source IP address 200. The source IP address will then shift into “persist” mode and send, at predetermined intervals, a TCP receive window probe, requesting authorization to continue sending data. These window probes are acknowledged by the method and system 4 by sending additional TCP packets maintaining a TCP receive window of zero byte size. Since the TCP receive window set by the virtually occupied IP address is of zero byte size, the source IP address will continue to wait for the virtually occupied IP address to authorize communications by increasing the window size to allow data to be transferred. Because the virtually occupied IP address only sends further TCP receive window communications of zero byte size to the source IP address to maintain the source IP address in the persist state, the automated scan is effectively trapped until a manual termination of the connection is performed.

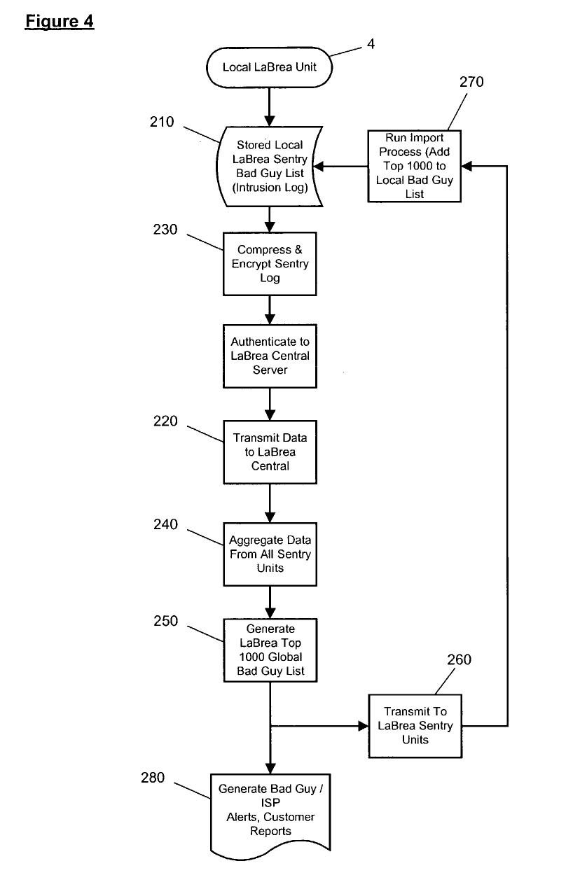

FIG. 4 is a continuation of the flow chart in FIG. 3 where the violator list 210 is sent to a central location 220 for compilation with violator lists of other systems of the claimed invention. Each local LaBrea™ Unit 4 is capable of compressing and encrypting the local computer network bad guy list 230 for transmission to a central receiving point via the Internet. The bad guy lists from each of the LaBrea™ system 4 are then aggregated 240 to form a global bad guy list 250 to be transmitted 260 back to each individual LaBrea™ system 4 via the Internet. This global bad guy or violator list 250 is then integrated 270 into each individual LaBrea™ system's 4 local bad guy or violator list 210. The global bad guy or violator list 250 may also be used to generate Internet service provider alerts and customer reports 280 regarding IP addresses placed on the global bad guy or violator list 250.

Although the invention has been described by reference to some embodiments it is not intended that the novel device be limited thereby, but that modifications thereof are intended to be included as falling within the broad scope and spirit of the foregoing disclosure, the following claims and the appended drawings.

I claim:

1. A method of preventing unauthorized intrusions into a local computer network, the method comprising:
monitoring local network computer responses to address resolution protocol requests sent in response to network connection attempts from an Internet protocol address;
recording status of local Internet protocol addresses as occupied local Internet protocol addresses when local Internet protocol addresses send address resolution protocol acknowledgements in response to address resolution protocol requests;
sending address resolution protocol acknowledgements from virtually occupied unused local Internet protocol addresses after a predetermined number of address resolution protocol requests from Internet protocol addresses do not receive address resolution protocol acknowledgements;
recording status of virtually occupied unused local Internet protocol addresses;
monitoring communications from Internet protocol addresses to determine whether communications are addressed to occupied local Internet protocol addresses or virtually occupied unused local Internet protocol addresses;
recording Internet protocol addresses as local violators when communication from Internet protocol addresses are directed to virtually occupied unused Internet protocol addresses;
allowing communication between occupied local Internet protocol addresses and Internet protocol addresses not recorded as local violators;
initiating counter measures against Internet protocol addresses sending communications to recorded virtually occupied unused Internet protocol addresses;
initiating the counter measures against recorded local violators sending communications to recorded occupied local Internet protocol addresses.

2. The method of claim 1 wherein the counter measures comprise sending reset packets to local Internet protocol addresses and to Internet protocol addresses making network connection attempts.

3. The method of claim 2 wherein the counter measures further comprise establishing connections with and ignoring further communications sent from Internet protocol addresses to recorded virtually occupied unused Internet protocol addresses.

4. The method of claim 3 wherein the counter measures further comprise sending transmission control protocol packets setting a receive window of zero byte size and answering window probe packets from Internet protocol addresses with further transmission control protocol packets maintaining a receive window of zero byte size.

5. The method of claim 4 further comprising changing parameters of the counter measures, the monitoring, and the recording via a secured Internet website.

6. The method of claim 5 further comprising encrypting initial sequence numbers found within initial transmission control protocol packet communications to create virtually occupied unused Internet protocol address initial sequence numbers.

7. The method of claim 6 further comprising limiting responses from virtually occupied unused Internet protocol addresses to only communications having returned the encrypted sequence numbers as acknowledgement numbers.

8. The method of claim 7 further comprising notifying a central receiving point of local violators at predetermined intervals.

9. The method of claim 8 further comprising augmenting the recording of local violators with local violator recordings from other networks.

10. A method of preventing unauthorized intrusions into a local computer network, the method comprising:
monitoring computer network responses to communications from Internet protocol addresses to local Internet protocol addresses;
recording status of local Internet protocol addresses as occupied local Internet protocol addresses when local Internet protocol addresses respond to communications or initiates communications;
sending response communications from virtually occupied Internet protocol addresses when occupied local Internet protocol addresses do not respond to the communications;
recording status of virtually occupied unused Internet protocol addresses;
monitoring communications from Internet protocol addresses to determine whether communications are directed to occupied local Internet protocol addresses or virtually occupied unused local Internet protocol addresses;
recording Internet protocol addresses as violators when communications from Internet protocol addresses are directed to virtually occupied unused Internet protocol addresses;
allowing communications between occupied local Internet protocol addresses and Internet protocol addresses not recorded as a violator;
initiating counter measures against Internet protocol addresses sending communications to virtually occupied unused Internet protocol addresses;
initiating the counter measures against violators sending communications to occupied local Internet protocol addresses.

11. The method of claim 10 wherein the counter measures comprise sending reset communications to local Internet protocol addresses and to Internet protocol addresses making network connection attempts.

12. The method of claim 11 wherein the counter measures comprise establishing connections with and ignoring further communications sent from Internet protocol addresses to virtually occupied unused Internet protocol addresses.

13. The method of claim 12 wherein the counter measures further comprise sending transmission control protocol packets setting a receive window of zero byte size and answering window probe packets from Internet protocol addresses with further transmission control protocol packets maintaining a receive window of zero byte size.

14. The method of claim 13 further comprising changing parameters of the counter measures, the monitoring, and the recording via a secured Internet website.

15. The method of claim 14 further comprising encrypting initial sequence numbers from Internet protocol addresses to create virtual sequence numbers.

16. The method of claim 15 further comprising limiting responses from virtually occupied unused Internet protocol addresses to only communications having returned the encrypted sequence numbers as acknowledgement numbers.

17. The method of claim 16 further comprising notifying a central receiving point of violators at predetermined intervals.

18. The method of claim 17 further comprising augmenting the violators with violators from other computer networks.

19. A method of protecting a computer network against unauthorized users probing the network for vulnerabilities, the method comprising:
monitoring a computer network for communications from Internet protocol addresses directed toward unused Internet protocol addresses within the computer network;
recording as violators Internet protocol addresses sending communications directed toward unused Internet protocol addresses within the computer network;
initiating counter measures against Internet protocol addresses recorded as violators.

20. The method of claim 19 wherein the counter measures comprise sending reset communications to the computer network and to Internet protocol addresses attempting communications with unused Internet protocol addresses.

21. The method of claim 19 wherein the counter measures further comprise communicating with and ignoring further communications sent from Internet protocol addresses to unused Internet protocol addresses.

22. The method of claim 21 wherein the counter measures further comprise sending transmission control protocol packets setting a receive window of zero byte size and answering transmission control protocol window probes from Internet protocol addresses with transmission control packets that maintain a receive window of zero byte size.

23. The method of claim 22 further comprising changing parameters of the counter measures, the monitoring, and the recording via a secured Internet website.

24. The method of claim 23 further comprising encrypting at least a portion of the acknowledgement communication sent to Internet protocol addresses.

25. The method of claim 24 further comprising limiting responses from the computer network to only Internet protocol addresses returning the encrypted portion of the acknowledgement communications.

26. The method of claim 25 further comprising notifying a central receiving point of violators.

27. The method of claim 26 further comprising augmenting the recording of violators with violators from other computer networks.

28. A system for protecting a computer network against unauthorized users probing the network for violators, the system comprising:
a monitoring means for monitoring communication packets sent locally in response to communications from Internet protocol addresses to local Internet protocol addresses;
a recording means for recording Internet protocol addresses attempting to send communications to unused local Internet protocol addresses;
a communication means for communicating with Internet protocol addresses, the communication means performing counter measures against recorded Internet protocol addresses.

29. The system of claim 28 wherein parameters of the monitoring means, recording means, and communications means are accessed from a central location via a secured Internet website.

30. The system of claim 29 wherein the communication means sends a partially encrypted transmission control protocol packet in response to transmission control protocol packets sent from Internet protocol addresses directed toward unused local Internet protocol addresses.

31. The system of claim 30 wherein the communication means establishes a connection with Internet protocol addresses attempting to send communications to unused local Internet protocol addresses and ignores further communications.

32. The system of claim 31 wherein the communication means sends reset communications to local Internet protocol addresses and Internet protocol addresses attempting to send communications to unused local Internet protocol addresses.

33. The system of claim 32 wherein the communication means sends a transmission control protocol packet setting a receive window of zero byte size and responds to transmission control protocol window probes from Internet protocol addresses by sending transmission control protocol packets maintaining a receive window of zero byte size.
